(19) United States
(12) Patent Application Publication
(10) Pub. No.: US 2025/0103037 A1
(43) Pub. Date: Mar. 27, 2025

(54) CERTIFICATION SYSTEM, CERTIFICATION METHOD, AND COMPUTER-READABLE RECORDING MEDIUM

(71) Applicant: Yokogawa Electric Corporation, Tokyo (JP)

(72) Inventors: Takaaki MATSUDA, Tokyo (JP); Hiroaki NAKAJIMA, Sugar Land, TX (US); Shin OKUYAMA, Tokyo (JP)

(21) Appl. No.: 18/373,715

(22) Filed: Sep. 27, 2023

(51) Int. Cl. G05B 23/02

(52) U.S. Cl. CPC G05B 23/0256

(57) ABSTRACT

A certification system includes a control device that constitutes a plant control system and a server device that executes certification of the control device. The server device executes a device unit test to determine whether a function set in the control device satisfies a predetermined condition specified by a standards organization and works normally; executes a standard application operation test to determine whether the control device satisfies a predetermined condition specified by the standards organization and can install and operate a standard application specified by the standards organization; executes a software load test to determine whether software of the control device satisfies a predetermined condition specified by the standards organization and can withstand a predetermined load; determines whether each of the test results of the device unit test, the standard application operation test, and the software load test satisfies a predetermined condition; and certifies that the control device is compliant with standards of the standards organization, based on the determination result.

### TECHNICAL FIELD

The present invention relates to a certification system, a certification method, and a computer-readable recording medium.

### BACKGROUND ART

For plant control systems used in many critical infrastructures, ensuring plant safety and availability is of utmost importance. Thus, there is a strong user demand for technology transferability and the industry structure is inevitably difficult for new system providers (SIers, system integrators, system vendors) and product providers (suppliers, product vendors) to enter. Such an industry structure is prone to incur vendor lock-in and causes increased operating costs and delays in technology development in plant control systems.

In recent years, in order to facilitate the application of the latest information technology (IT) and the entry of new businesses by constructing plant control systems with open technology, standards organizations such as Open Process Automation (OPA), Module Type Package (MTP), and NAMUR Open Architecture (NOA) have been making an active effort to standardize plant control systems.

### CITATION LIST

### Patent Literature

Patent Literature 1: U.S. Pat. No. 9,912,737

### SUMMARY

### Technical Problem

An object of the present invention is to efficiently certify that a control device that constitutes a plant control system is compliant with the standards of a standards organization.

### Solution to Problem

The present invention provides a certification system including a control device that constitutes a plant control system, and a certification device that executes certification of the control device, the certification device including an executer configured to execute a device unit test to determine whether a function set in the control device satisfies a predetermined condition specified by a standards organization and works normally, execute a standard application operation test to determine whether the control device satisfies a predetermined condition specified by the standards organization and is capable of installing and operating a standard application specified by the standards organization, and execute a software load test to determine whether software of the control device satisfies a predetermined condition specified by the standards organization and is capable of withstanding a predetermined load, a determiner configured to determine whether each of test results of the device unit test, the standard application operation test, and the software load test satisfies a predetermined condition, and a certifier configured to certify that the control device is compliant with standards of the standards organization, based on the determination result.

The present invention provides a certification method executed in a certification system including a control device that constitutes a plant control system, and a certification device that executes certification of the control device, wherein the certification device performs processing including executing a device unit test to determine whether a function set in the control device satisfies a predetermined condition specified by a standards organization and works normally, executing a standard application operation test to determine whether the control device satisfies a predetermined condition specified by the standards organization and is capable of installing and operating a standard application specified by the standards organization, executing a software load test to determine whether software of the control device satisfies a predetermined condition specified by the standards organization and is capable of withstanding a predetermined load, determining whether each of test results of the device unit test, the standard application operation test, and the software load test satisfies a predetermined condition, and certifying that the control device is compliant with standards of the standards organization, based on the determination result.

The present invention provides a computer-readable recording medium storing therein a certification program for causing a certification device that executes certification of a control device that constitutes a plant control system to execute processing including executing a device unit test to determine whether a function set in the control device satisfies a predetermined condition specified by a standards organization and works normally, executing a standard application operation test to determine whether the control device satisfies a predetermined condition specified by the standards organization and is capable of installing and operating a standard application specified by the standards organization, executing a software load test to determine whether software of the control device satisfies a predetermined condition specified by the standards organization and is capable of withstanding a predetermined load, determining whether each of test results of the device unit test, the standard application operation test, and the software load test satisfies a predetermined condition, and certifying that the control device is compliant with standards of the standards organization, based on the determination result.

### BRIEF DESCRIPTION OF DRAWINGS

FIG. 1 is a diagram illustrating an example of the flow of provision of a plant control system;

FIG. 2 is a diagram illustrating a configuration example and a process example of a certification system according to an embodiment;

FIG. 3 is a block diagram illustrating a configuration example of each device in the certification system according to the embodiment;

FIG. 4 is a diagram illustrating an example of a test result storage of a server device according to the embodiment;

FIG. 5 is a diagram illustrating an example of a determination result storage of the server device according to the embodiment;

FIG. 6 is a diagram illustrating an example of a certification result storage of the server device according to the embodiment;

FIG. 7 is a flowchart illustrating an example of the process flow of the entire certification system according to the embodiment;

FIG. 8 is a flowchart illustrating an example of the flow of a test result output process of the certification system according to the embodiment;

FIG. 9 is a flowchart illustrating an example of the flow of a determination result output process of the certification system according to the embodiment;

FIG. 10 is a flowchart illustrating an example of the flow of a certification result output process of the certification system according to the embodiment; and

FIG. 11 is a diagram illustrating a hardware configuration example according to the embodiment.

### DESCRIPTION OF EMBODIMENTS

A certification system, a certification method, and a computer-readable recording medium according to an embodiment of the present invention will be described in detail below with reference to the drawings. It should be noted that the present invention is not limited by the embodiment described below.

### Embodiment

Configurations and processes of a certification system, configurations and processes of a certification device and the like, and a flow of the processes according to the embodiment will be described in sequence below, and the effects of the embodiment will be described lastly.

### 1. Configuration and Process of Certification System 100

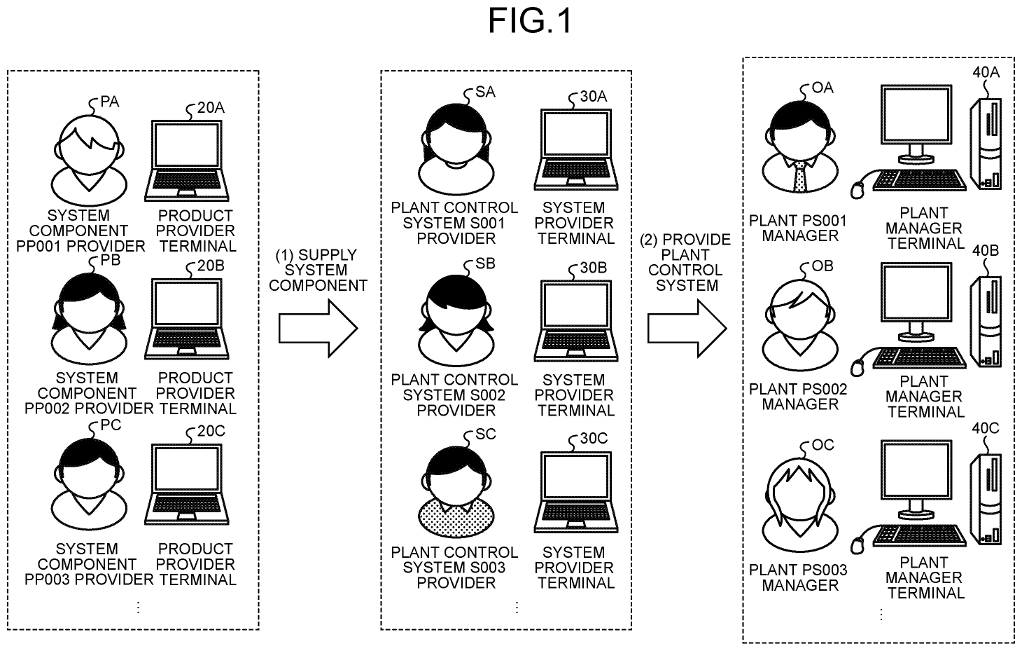

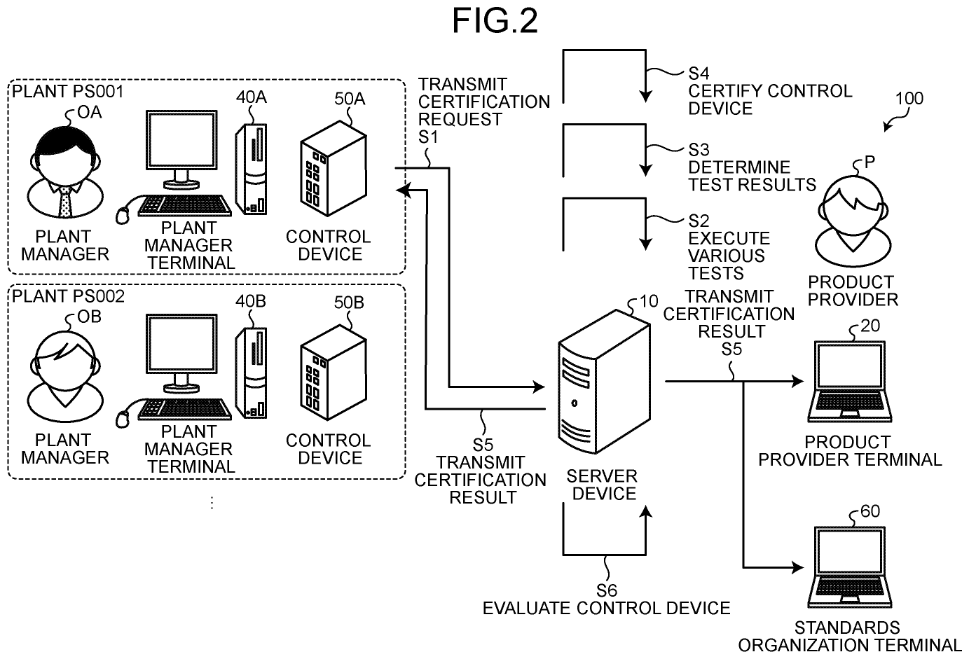

Referring to FIGS. 1 and 2, a configuration and a process of a certification system 100 according to the embodiment will be described in detail. In the following, the background of the provision of a plant control system will be described and then a configuration example of the entire certification system 100, a process example of the certification system 100, and effects of the certification system 100 will be described in this order.

### 1-1. Background of Provision of Plant Control System

Referring to FIG. 1, the background of the provision of a plant control system will be described. FIG. 1 is a diagram illustrating an example of the flow of provision of the plant control system. In the following, a configuration example of provision of the plant control system, an example of the flow of provision of the plant control system, and the background of the plant control system will be described in this order.

### 1-1-1. Configuration Example of Provision of Plant Control System

As illustrated in the example in FIG. 1, the provision of the plant control system involves product providers P (PA, PB, PC, . . . ) providing system components such as hardware and software, which are constituents of the plant control system, system providers S (SA, SB, SC, . . . ) providing plant control systems, and plant managers O (OA, OB, OC, . . . ) managing plants in which plant control systems are introduced. As illustrated in the example in FIG. 1, the provision of the plant control system also involves product provider terminals 20 (20A, 20B, 20C, . . . ) used by the product providers P (PA, PB, PC, . . . ) respectively, system provider terminals 30 (30A, 30B, 30C, . . . ) used by the system providers S (SA, SB, SC, . . . ) respectively, and plant manager terminals 40 (40A, 40B, 40C, . . . ) used by the plant managers O (OA, OB, OC, . . . ) respectively.

In the example in FIG. 1, the product provider PA provides a system component PP001, the product provider PB provides a system component PP002, and the product provider PC provides a system component PP003. In the example in FIG. 1, the system provider SA provides a plant control system S001, the system provider SB provides a plant control system S002, and the system provider SC provides a plant control system S003. In the example in FIG. 1, the plant manager OA manages a plant PS001, the plant manager OB manages a plant PS002, and the plant manager OC manages a plant PS003.

### 1-1-2. Example of Flow of Provision of Plant Control System

An example of the flow of provision of the plant control system will be described in the following order: system component provision (see FIG. 1 (1)) and plant control system provision (see FIG. 1 (2)). As illustrated in the example in FIG. 1 (1), the product providers P deliver system components to the system providers S. For example, the product provider PA delivers the system component PP001, which is a constituent of the plant control system S001 under development by the system provider SA. As illustrated in the example in FIG. 1 (2), the system providers S deliver plant control systems to the plant managers O. For example, the system provider SA constructs the plant control system S001 in the plant PS001 managed by the plant manager OA.

### 1-1-3. Background of Plant Control System

In the plant control systems as described above, the system providers S have accumulated many years of experience and achievements to ensure plant safety and availability. In doing so, the system providers S optimize the operation of the plant control systems by analyzing the accumulated experience and troubles and conducting many experiments and simulations. In other words, the safe operation of plants by existing system providers S is premised on spending a lot of time and money and cannot be easily provided to third parties. Further, for new system providers S having no plant experience to compete with existing system providers S, it is difficult to be provided with information from existing system providers S. As a result, the industry structure is difficult for new system providers S and product providers P to enter and tends to incur vendor lock-in, causing increased operating costs and delays in technology development for plant control systems.

As described above, the industry related to plant control systems is prone to oligopoly by some existing system providers S. On the other hand, the entry of new system providers S and product providers P is expected to revitalize the industry related to plant control systems. In other words, new entry of system providers S and the like is expected to stimulate technological development in the industry as a whole and improve system performance. Against this background, in order to facilitate the application of the latest IT and the entry of new businesses by constructing plant control systems with open technology, standards organizations such as OPA have been making an active effort to standardize plant control systems. However, it is still not easy even for technology or companies certified as standards to enter the industry, for example, in terms of operation experience in actual plants and reliability.

As described above, the industry related to plant control systems is seeking to improve the technology and safety in the industry related to the plant control systems as a whole by developing technology that serves as a bridge for entry of new system providers S and the like and information provision technology for selecting an appropriate system provider S from among a wide variety of system providers S and the like.

The invention of the subject application proposes a technology to promote openness and improve the safe operation and availability of plants by constructing a system that efficiently certifies that a control device 50 that constitutes a plant control system is compliant with the standards of a standards organization.

### 1-2. Configuration Example of Certification System 100

Referring to FIG. 2, a configuration example of the certification system 100 according to the embodiment will be described. FIG. 2 is a diagram illustrating a configuration example and a process example of the certification system 100 according to the embodiment. The certification system 100 includes a server device 10 which is a certification device, plant manager terminals 40 (40A, 40B) which are posting terminals and viewing terminals, control devices 50 (50A, 50B) for controlling plant devices, a product provider terminal 20 which is a viewing terminal, and a standards organization terminal 60 which is a viewing terminal. Here, the server device 10, the plant manager terminals 40, the control devices 50, the product provider terminals 20, and the standards organization terminal 60 are communicatively connected in a wired or wireless manner through a not-illustrated predetermined communication network. Various communication networks, such as the Internet and leased lines, can be used as the predetermined communication network. The certification system 100 illustrated in FIG. 2 may include a plurality of server devices 10, a plurality of product provider terminals 20, or a plurality of standards organization terminals 60. The certification system 100 illustrated in FIG. 2 may also include a system provider terminal 30 which is a viewing terminal.

### 1-3. Process Example of Certification System 100

A process example of the entire certification system 100 described above will be described. The processes at steps S1 to S6 below can be performed in a different order. Some of the processes at steps S1 to S6 below may be omitted.

### 1-3-1. Certification Request Transmission Process

First, the control device 50 transmits a request for certification of a standards organization (step S1). For example, the control device 50A transmits to the server device 10 a request for certification of OPA, one of the standards organizations, input by the plant manager OA via the plant manager terminal 40A.

### 1-3-2. Test Execution Process

Second, the server device 10 executes various tests (step S2). For example, the server device 10 executes a device unit test, a standard application operation test, and a software load test for the control device 50A that has transmitted the request for certification of OPA. In addition, the server device 10 executes a device interconnection test, a device data linkage test, an external application operation test, an application migration test, and a trouble test for the control device 50A.

As used herein, the device unit test is a test to determine whether a function set in the control device 50 satisfies a predetermined condition specified by the standards organization and works normally.

The standard application operation test is a test to determine whether the control device 50 satisfies a predetermined condition specified by the standards organization and can install and operate a standard application specified by the standards organization.

The software load test is a test to determine whether software of the control device 50 satisfies a predetermined condition specified by the standards organization and can withstand a predetermined load.

The device interconnection test is a test to determine whether the control device 50 can be interconnected with a control device 50′ from a different manufacturer.

The device data linkage test is a test to determine whether the control device 50 can transmit and receive predetermined data to/from the control device 50′ from a different manufacturer.

The external application operation test is a test to determine whether the control device 50 can install and operate a predetermined external application different from the standard application.

The application migration test is a test to determine whether the control device 50 can migrate an application installed in the control device 50 to the control device 50′ from a different manufacturer.

The trouble test is a test to determine whether the control device 50 can withstand a predetermined trouble.

### 1-3-3. Test Result Determination Process

Third, the server device 10 determines a test result (step S3). For example, the server device 10 determines whether each of the test result of the device unit test, the test result of the standard application operation test, and the test result of the software load test, output by the control device 50A, satisfies a predetermined condition. Furthermore, the server device 10 determines whether each of the test result of the device interconnection test, the test result of the device data linkage test, the test result of the external application operation test, the test result of the application migration test, and the test result of the trouble test, output by the control device 50A, satisfies a predetermined condition.

In doing so, the server device 10 may terminate the test result determination process if a predetermined test result does not satisfy a predetermined condition. For example, if even one of the test result of the device unit test, the test result of the standard application operation test, and the test result of the software load test, output by the control device 50A, does not satisfy a predetermined condition, the server device 10 may terminate the test result determination process without determining the other test results.

### 1-3-4. Control Device Certification Process

Fourth, the server device 10 certifies the control device 50 (step S4). For example, if all of the determination result of the device unit test, the determination result of the standard application operation test, and the determination result of the software load test are “determination result: Pass” indicating that the test result satisfies a predetermined condition, the server device 10 certifies that the control device 50A is compliant with the standards of OPA that is one of the standards organizations (OPA standards (O-PAS)), and generates a certification result indicating that the control device 50A has been certified by OPA. On the other hand, if at least one of the determination result of the device unit test, the determination result of the standard application operation test, and the determination result of the software load test is “determination result: Fail” indicating that the test result does not satisfy a predetermined condition, the server device 10 does not certify that the control device 50A is compliant with the standards of OPA that is one of the standards organization, and generates a certification result indicating that the control device 50A has not been certified by OPA.

In doing so, the server device 10 may certify the control device 50 according to the number of “determination results: Pass” or the determination result of a specified test. For example, if all of the determination result of the device unit test, the determination result of the standard application operation test, and the determination result of the software load test are “determination result: Pass” and, in addition, three or more determination results are “determination result: Pass” in tests other than the above tests, the server device 10 certifies that the control device 50A is compliant with the OPA standards. If all of the determination result of the device unit test, the determination result of the standard application operation test, and the determination result of the software load test are “determination result: Pass” and, in addition, both of the determination result of the device interconnection test and the determination result of the device data linkage test specified by OPA are “determination result: Pass”, the server device 10 certifies that the control device 50A is compliant with the OPA standards.

Further, the server device 10 can register that the control device 50A has been certified by OPA and issue a certificate certifying that the control device 50A has been certified by OPA. In addition, the server device 10 can register that the control device 50A has been certified by OPA and create a device list indicating the control devices 50 that have been certified by OPA.

### 1-3-5. Certification Result Transmission Process

Fifth, the server device 10 transmits a certification result (step S5). For example, the server device 10 transmits, to the plant manager terminal 40A, the certification result for the control device 50A indicating that the control device 50A has been certified by OPA. In doing so, the server device 10 can also transmit, to the plant manager terminal 40A, a certificate certifying that the control device 50A has been certified by OPA. On the other hand, the server device 10 may transmit, to the plant manager terminal 40A, the certification result for the control device 50A indicating that the control device 50A has not been certified by OPA.

Further, the server device 10 transmits the certification result indicating that the control device 50A has been certified by OPA to the product provider terminal 20 and the standards organization terminal 60. In doing so, the server device 10 can also transmit a device list indicating the control devices 50 that have been certified by OPA to the product provider terminal 20 and the standards organization terminal 60.

### 1-3-6. Control Device Evaluation Process

Sixth, the server device 10 evaluates the control device 50 (step S6). For example, for the control device 50A certified as compliant with the OPA standards, the server device 10 evaluates the control device 50.

In doing so, the server device 10 calculates an evaluation score (e.g., out of 5 points) or an evaluation rank (e.g., 5-point scale with stars or alphabets), based on the degree to which each test result satisfies a predetermined condition.

Further, the server device 10 transmits the evaluation score or the evaluation rank of the control device 50A to the product provider terminal 20 and the standards organization terminal 60.

### 1-4. Effects of Certification System 100

In the following, an overview of the plant control system and the issue with a reference technology will be described and then effects of the certification system 100 will be described.

### 1-4-1. Overview of Plant Control System

Plant control systems used in many critical infrastructures often place the highest priority on safety and long-term continuous operation. On the other hand, devices and software for plant control systems are often supplied by a single vendor. This impedes the acceleration of innovation (which is called vendor lock-in). In response, the standardization activities (e.g., OPA, MTP, NOA) have been active in plant control systems in order to introduce multiple vendors.

However, in plant control systems, introducing multiple vendors complicates potential or visible issues because it diversifies the combination of devices and software that are system components. Multiple vendors are therefore undesirable in some aspects for safety and long-term continuous operation.

### 1-4-2. Overview of Reference Technology

The reference technology described in Patent Literature 1 relates to a technology for standardization activities for plant control systems. The reference technology provides a system for controlling an industrial process using a plurality of distributed control nodes (DCN), the system including a plurality of device DCNs, each device DCN including an input/output (I/O) interface coupled with a field device for single channel input or output, a plurality of Application DCNs, and one or more Ethernet (registered trademark) switches, wherein the device DCNs and the Application DCNs are adapted to host a software runtime and communicatively coupled via the one or more Ethernet (registered trademark) switches.

1-4-3. Issue with Reference Technology

In a multi-vendor plant control system in compliance with the OPA standards, it is necessary to efficiently conduct a certification test for compliance with the OPA standards, because plant devices are provided by more various product providers P than in a single-vendor plant control system. Therefore, there is a need for a technology that automatically executes a certification test for compliance with the OPA standards and easily improves the efficiency of certification tests. However, in the reference technology, OPA workers are sent to a plant to conduct a certification test of the control device 50, making it difficult to automatically execute a certification test.

### 1-4-4. Overview of Certification System 100

The certification system 100 includes a control device 50 that constitutes a plant control system and a server device 10 that executes certification of the control device 50. In the certification system 100, the server device 10 executes a device unit test to determine whether a function set in the control device 50 satisfies a predetermined condition specified by a standards organization such as OPA and works normally; executes a standard application operation test to determine whether the control device 50 satisfies a predetermined condition specified by the standards organization such as OPA and can install and operate a standard application specified by the standards organization such as OPA; executes a software load test to determine whether software of the control device 50 satisfies a predetermined condition specified by the standards organization such as OPA and can withstand a predetermined load; determines whether each of the test results of the device unit test, the standard application operation test, and the software load test satisfies a predetermined condition; and certifies that the control device 50 is compliant with standards of the standards organization such as OPA, based on the determination result.

In doing to, the server device 10 may further execute a device interconnection test, a device data linkage test, an external application operation test, an application migration test, and a trouble test. Further, the server device 10 may create a device list of certified control devices 50 and issue a certificate for the certified control device 50. Further, the server device 10 may evaluate the certified control device 50 and transmit the evaluation result to the product provider terminal 20 and the standards organization terminal 60.

### 1-4-5. Effects

The certification system 100 can automatically execute a certification test to determine whether the control device 50 is compliant with the standards of OPA or the like in a multi-vendor plant control system including plant devices from various product providers P.

In addition, the certification system 100 can solve the overall structural issues of the industry related to plant control systems by constructing a system that efficiently certifies that a control device that constitutes a plant control system is compliant with the standards of a standards organization.

### 2. Configuration and Process of Each Device in Certification System 100

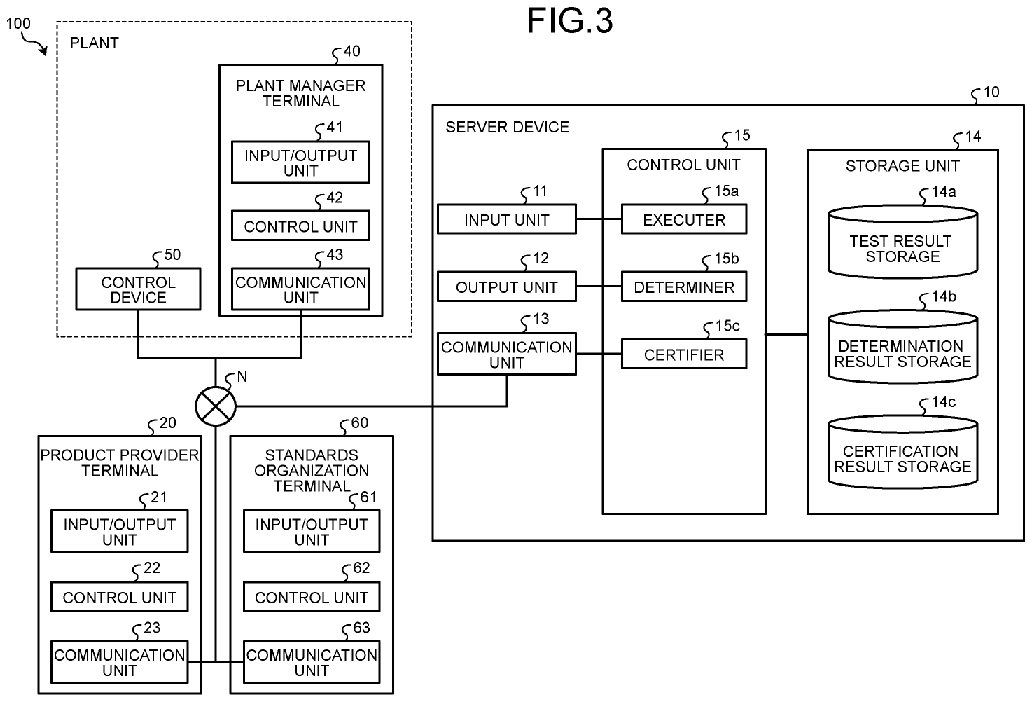

Referring to FIG. 3, a functional configuration of each device in the certification system 100 illustrated in FIG. 2 will be described. In the following, a configuration example of the entire certification system 100 according to the embodiment will be described, and then a configuration example and a process example of the server device 10, a configuration example and a process example of the product provider terminal 20, a configuration example and a process example of the plant manager terminal 40, a configuration example and a process example of the control device 50, and a configuration example and a process example of the standards organization terminal 60 will be described in detail.

### 2-1. Configuration Example of Entire Certification System 100

Referring to FIG. 3, a configuration example of the entire certification system 100 illustrated in FIG. 2 will be described. FIG. 3 is a block diagram illustrating a configuration example of each device in the certification system 100 according to the embodiment. As illustrated in FIG. 3, the certification system 100 includes a server device 10, a product provider terminal 20, a plant manager terminal 40, a control device 50, and a standards organization terminal 60. The server device 10, the product provider terminal 20, the plant manager terminal 40, the control device 50, and the standards organization terminal 60 are communicatively connected via a communication network N implemented by the Internet or a leased line. The plant manager terminal 40 and the control device 50 are installed in a plant.

### 2-2. Configuration Example of Server Device 10

Referring to FIG. 3, a configuration example of the server device 10 illustrated in FIG. 2 will be described. The server device 10 is a certification device that executes certification of the control device 50 by a standards organization, and includes an input unit 11, an output unit 12, a communication unit 13, a storage unit 14, and a control unit 15.

Here, the standards organization is OPA, MTP, or NOA. In addition to the above, the standards organization includes organizations that standardize plant control systems using IT for plant operation control, and organizations that standardize various products used in plant control systems.

### 2-2-1. Input Unit 11

The input unit 11 governs the input of various information to the server device 10. For example, the input unit 11 is implemented by a mouse, a keyboard, and the like and accepts inputs such as setting information to the server device 10.

### 2-2-2. Output Unit 12

The output unit 12 governs the output of various information from the server device 10. For example, the output unit 12 is implemented by a display and the like and outputs setting information and the like stored in the server device 10.

### 2-2-3. Communication Unit 13

The communication unit 13 governs data communication with other devices. For example, the communication unit 13 performs data communication with each communication device via routers and the like. Further, the communication unit 13 can perform data communication with a not-illustrated operator's terminal.

### 2-2-4. Storage Unit 14

The storage unit 14 stores therein various information referred to when the control unit 15 operates, as well as various information acquired when the control unit 15 operates. The storage unit 14 includes a test result storage 14a, a determination result storage 14b, and a certification result storage 14c. Here, the storage unit 14 can be implemented, for example, by a semiconductor memory element such as a random-access memory (RAM) or a flash memory, or a storage device such as a hard disk or an optical disc. In the example in FIG. 3, the storage unit 14 is installed inside the server device 10 but may be installed outside the server device 10, and a plurality of storage units may be installed.

### 2-2-4-1. Test Result Storage 14a

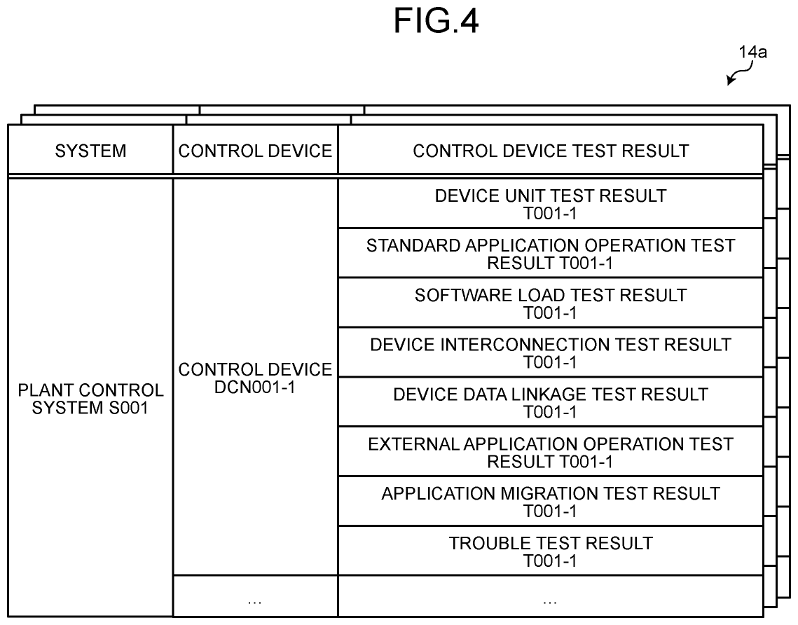

The test result storage 14a stores therein the result of a test executed by an executer 15a described later. Referring now to FIG. 4, an example of data stored by the test result storage 14a will be described. FIG. 4 is a diagram illustrating an example of the test result storage 14a of the server terminal 10 according to the embodiment. In the example in FIG. 4, the test result storage 14a has items such as “system”, “control device”, and “control device test result”.

“System” indicates identification information for identifying the plant control system, for example, the identification number or identification symbol of the plant control system. “Control device” indicates identification information for identifying the control device 50 that constitutes the plant control system, for example, the identification number or identification symbol of the control device 50. “Control device test result” indicates the results of various tests executed by the executer 15a, for example, a signal output by the control device 50 during test execution.

More specifically, in the example in FIG. 4, the test result storage 14a stores therein data in which for the plant control system identified by “plant control system S001”, the test result “control device test result” of the control device 50 identified by “control device DCN001-1” includes “device unit test result T001-1”, “standard application operation test result T001-1”, “load test result T001-1”, “device interconnection test result T001-1”, “device data linkage test result T001-1”, “external application operation test result T001-1”, “application migration test result T001-1”, and “trouble test result T001-1”.

### 2-2-4-2. Determination Result Storage 14b

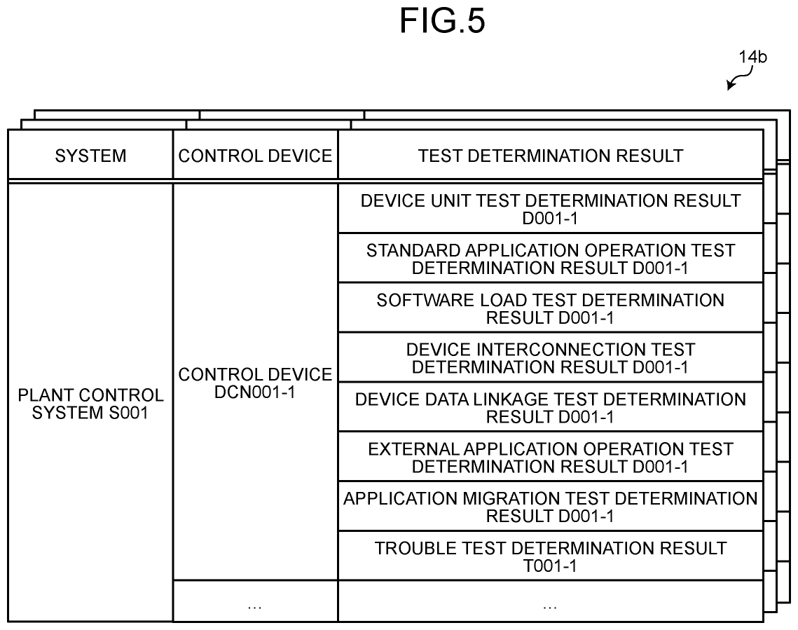

The determination result storage 14b stores therein a determination result output by a determiner 15b described later. Referring now to FIG. 5, an example of data stored by the determination result storage 14b will be described. FIG. 5 is a diagram illustrating an example of the determination result storage 14b of the server device 10 according to the embodiment. In the example in FIG. 5, the determination result storage 14b has items such as “system,” “control device,” and “test determination result”.

“System” indicates identification information for identifying the plant control system, for example, the identification number or identification symbol of the plant control system. “Control device” indicates identification information for identifying the control device 50 that constitutes the plant control system, for example, the identification number or identification symbol of the control device 50. The “test determination result” indicates the result of determining various tests that is output by the determiner 15b, for example, “Pass” indicating that the test result satisfies a predetermined condition, and “Fail” indicating that the test result does not satisfy a predetermined condition.

More specifically, in the example illustrated in FIG. 5, the determination result storage 14b stores therein data in which for the plant control system identified by “plant control system S001”, the test determination result “test determination result” of the control device 50 identified by “control device DCN001-1” includes “device unit test result D001-1”, “standard application operation test result D001-1”, “load test result D001-1”, “device interconnection test result D001-1”, “device data linkage test result D001-1”, “external application operation test result D001-1”, “application migration test result D001-1”, and “trouble test result D001-1”.

### 2-2-4-3. Certification Result Storage 14c

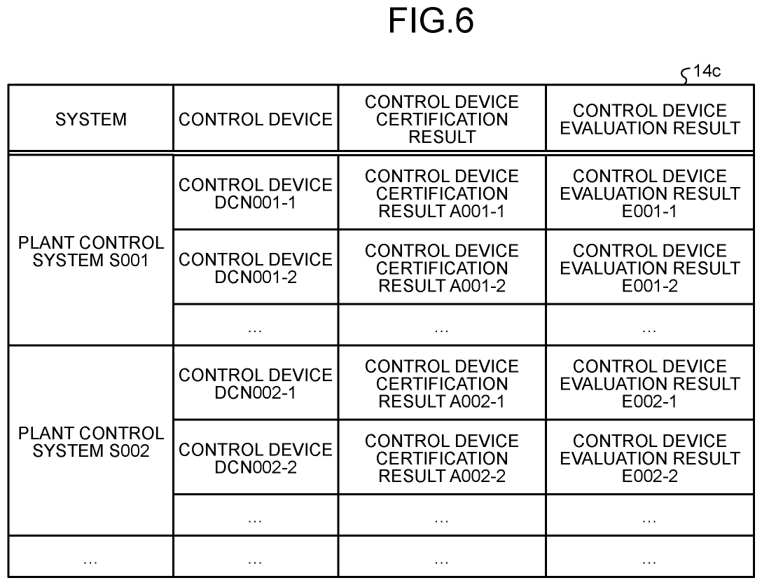

The certification result storage 14c stores therein the certification result and the evaluation result output by a certifier 15c described later. Referring now to FIG. 6, an example of data stored by the certification result storage 14c will be described. FIG. 6 is a diagram illustrating an example of the certification result storage 14c of the server device 10 according to the embodiment. In the example in FIG. 6, the certification result storage 14c has items such as “system”, “control device”, “control device certification result”, and “control device evaluation result”.

“System” indicates identification information for identifying the plant control system, for example, the identification number or identification symbol of the plant control system. “Control device” indicates identification information for identifying the control device 50 that constitutes the plant control system, for example, the identification number or identification symbol of the control device 50. “Control device certification result” indicates the certification result of the control device 50 output by the certifier 15c, for example, “Pass” indicating compliance with the standards of a standards organization such as OPA, and “Fail” indicating no compliance with the standards of a standards organization such as OPA. “Control device evaluation result” indicates the evaluation result of the control device 50 output by the certifier 15c, for example, a score or a rank indicating the degree of compliance with the standards of a standards organization such as OPA.

More specifically, in the example illustrated in FIG. 6, the certification result storage 14c stores therein data in which for a plant control system identified by “plant control system S001”, a control device 50A-1 identified by “control device DCN001-1” has {control device certification result: “control device certification result A001-1”, control device certification result: “control device evaluation result E001-1”} and a control device 50A-2 identified by “control device DCN001-2” has {control device certification result: “control device certification result A001-2”, control device certification result: “control device evaluation result E001-2”}; and for a plant control system identified by “plant control system S002”, a control device 50B-1 identified by “control device DCN002-1” has {control device certification result: “control device certification result A002-1”, control device certification result: “control device evaluation result E002-1”} and a control device 50B-2 identified by “control device DCN002-2” has {control device certification result: “control device certification result A002-2”, control device certification result: “control device evaluation result E002-2”}.

### 2-2-5. Control Unit 15

The control unit 15 governs the control of the entire server device 10. The control unit 15 includes the executer 15a, the determiner 15b, and the certifier 15c. Here, the control unit 15 can be implemented, for example, by an electronic circuit such as a central processing unit (CPU), a micro processing unit (MPU), or a graphics processing unit (GPU), or by an integrated circuit such as an application specific integrated circuit (ASIC) or a field programmable gate array (FPGA).

### 2-2-5-1. Executer 15a

The executer 15a executes a certification request reception process and test execution processes (device unit test execution process, standard application operation test execution process, software load test execution process, device interconnection test execution process, device data linkage test execution process, external application operation test execution process, application migration test execution process, and trouble test execution process).

### Certification Request Reception Process

The executer 15a receives, as a certification request, a request to certify that the control device 50 is compliant with the standards of a standards organization. The executer 15a may store the received certification request in the storage unit 14.

For example, the executer 15a receives a request for certification on OPA, one of the standards organizations, from the control device 50A managed by the plant manager OA who is a user of the plant control system. The executer 15a also receives a request for certification on OPA, one of the standards organizations, from the plant manager terminal 40B used by the plant manager OB who is a user of the plant control system.

### Test Execution Process 1: Device Unit Test Execution Process

The executer 15a executes the device unit test to determine whether a function set in the control device 50 satisfies a predetermined condition specified by the standards organization and works normally.

Here, the device unit test is, for example, a test to determine whether input of a predetermined signal results in output specified by OPA. The predetermined signal is, for example, a signal defined by various communication standards, such as a current of 4 to 20 mA or a voltage of 1 to 5 V. The signal may be a digital signal or an analog signal.

The function set in the control device 50 is, for example, an input/output signal conversion function, a control function, a system network communication function, and a function of connection with an OPA standards non-compliant system. The predetermined condition specified by the standards organization is, for example, the executability of software specified to be implemented for each device that performs a function. The software specified is, for example, an operating system (OS), or an application for executing various functions or for monitoring a hardware state. Satisfying a predetermined condition specified by another standards organization may be considered as satisfying a predetermined condition specified by a predetermined standards organization.

In doing so, the executer 15a inputs a predetermined signal to the control device 50 and outputs the result corresponding to the input signal as a test result of the device unit test. Further, the executer 15a stores the test result of the device unit test into the test result storage 14a in association with the identification information of the control device 50 subjected to the device unit test. The executer 15a may store the test result into the test result storage 14a additionally in association with information about the input signal and information about the function set in the control device 50.

### Test Execution Process 2: Standard Application Operation Test Execution Process

The executer 15a executes the standard application operation test to determine whether the control device 50 satisfies a predetermined condition specified by a standards organization and can install and operate a standard application specified by the standards organization.

Here, the device unit test is, for example, the standard application operation test is, for example, a test as to whether a standard application specified by OPA can be installed and the operation status after installation.

The predetermined condition specified by the standards organization is, for example, the executability on a device that serves the function of each standard application. Satisfying a predetermined condition specified by another standards organization may be considered as satisfying a predetermined condition specified by a predetermined standards organization. The standard application is, for example, an OS or an application for executing various functions or for monitoring a hardware state, such as hardware state monitoring application, communication state monitoring application, and security monitoring application.

In doing so, the executer 15a executes installation of a standard application downloaded from an external system, for example. After installing a standard application, the executer 15a executes startup and predetermined processes and outputs whether the standard application can be installed, the startup status of the standard application, and the execution result of a predetermined process, as a test result of the standard application operation test. Further, the executer 15a stores the test result of the standard application operation test into the test result storage 14a in association with the identification information of the control device 50 subjected to the standard application operation test. The executer 15a may store the test result into the test result storage 14a additionally in association with information about the standard application, such as the identification information and the kind of the standard application.

### Test Execution Process 3: Software Load Test Execution Process

The executer 15a executes the software load test to determine whether software of the control device 50 satisfies a predetermined condition specified by the standards organization and can withstand a predetermined load.

Here, the software load test is, for example, a test to determine whether software of the control device 50 can withstand at least one of the data communication volume and the data processing volume specified by OPA.

The predetermined condition specified by the standards organization is, for example, a control period of 1 second. Satisfying a predetermined condition specified by another standards organization may be considered as satisfying a predetermined condition specified by a predetermined standards organization. The software is, for example, software for control or for communication to apply a load by actually or virtually increasing at least one of the data communication volume and the data processing volume.

In doing so, the executer 15a executes at least one of the data communication volume and the data processing volume, for example, using predetermined software installed in the server device 10 in advance. Further, the executer 15a outputs the status of at least one of the data communication volume and the data processing volume as a test result of the software load test. Further, the executer 15a stores the test result of the software load test into the test result storage 14a in association with the identification information of the control device 50 subjected to the software load test. The executer 15a may store the test result into the test result storage 14a additionally in association with information about the software, such as the identification information and the kind of the software.

### Test Execution Process 4: Device Interconnection Test Execution Process

The executer 15a executes the device interconnection test to determine whether the control device 50 can interconnect with a control device 50′ from a different manufacturer.

Here, the device interconnection test is, for example, a test to determine whether the control device 50, connected to the control device 50′, operates normally. The control device 50′ may be a device from a product provider P that is a manufacturer different from that of the control device 50, such as a computer with server functions, a monitoring tool, and various devices, and may be a physical device or may be a virtual device.

The predetermined condition specified by a standards organization is, for example, communication availability according to standards such as Open Platform Communications Unified Architecture (OPC-UA) and Redfish. Satisfying a predetermined condition specified by another standards organization may be considered as satisfying a predetermined condition specified by a predetermined standards organization.

In doing so, for example, when the control device 50′ is a physical device, the executer 15a accepts, as a predetermined input, input to an input device to start the test, such as a start button installed on the control device 50 or the control device 50′, and executes the device interconnection test. When the control device 50′ is a virtual device, the executer 15a accepts, for example, input to start the test as a predetermined input and executes the device interconnection test. Further, the executer 15a executes connection of the control device 50′ and operation check and outputs the connection execution result and the operation check result as a test result of the device interconnection test. Further, the executer 15a stores the test result of the device interconnection test into the test result storage 14a in association with the identification information of the control device 50 subjected to the device interconnection test. The executer 15a may store the test result into the test result storage 14a additionally in association with the identification information of the control device 50′ and the like connected to the control device 50.

### Test Execution Process 5: Device Data Linkage Test Execution Process

The executer 15a executes the device data linkage test to determine whether the control device 50 can transmit and receive predetermined data to/from a control device 50′ from a different manufacturer.

Here, the device data linkage test is, for example, a test to determine whether predetermined data can be transmitted and received between the control device 50 and the control device 50′. The predetermined data is, for example, a process value, an operation value, an alarm, and data on a device operating state. The control device 50′ may be a device from a product provider P that is a manufacturer different from that of the control device 50, such as a computer with server functions, a monitoring tool, and various devices, and may be a physical device or may be a virtual device.

The predetermined condition specified by the standards organization is, for example, whether data can be output in the data format specified by OPA. In other words, if the control device 50 can output data in the specified data format, the data can be input to and read by the control device 50′ from a different manufacturer. Satisfying a predetermined condition specified by another standards organization may be considered as satisfying a predetermined condition specified by a predetermined standards organization.

In doing so, for example, when the control device 50′ is a physical device, the executer 15a accepts, as a predetermined input, input to an input device to start the test, such as a start button installed on the control device 50 or the control device 50′, and executes the device data linkage test. When the control device 50′ is a virtual device, the executer 15a accepts, for example, input to start the test as a predetermined input and executes the device data linkage test. Further, the executer 15a executes the transmission and reception of predetermined data between the control device 50 and the control device 50′, and outputs the result of transmission and reception of the predetermined data as a test result of the device data linkage test. Further, the executer 15a stores the test result of the device data linkage test into the test result storage 14a in association with the identification information of the control device 50 subjected to the device data linkage test. The executer 15a may store the test result into the test result storage 14a additionally in association with the identification information of the control device 50′ linked with the control device 50. The executer 15a may store the test result into the test result storage 14a additionally in association with information on data transmitted and received, such as the kind of the predetermined data transmitted and received.

### Test Execution Process 6: External Application Operation Test Execution Process

The executer 15a executes the external application operation test to determine whether the control device 50 can install and operate a predetermined external application different from the standard application.

Here, the external application operation test is, for example, a test as to whether an external application other than the standard application specified by OPA can be installed and the operation status after installation.

The predetermined condition specified by the standards organization is, for example, the executability on a device that serves the function of the external application. Satisfying a predetermined condition specified by another standards organization may be considered as satisfying a predetermined condition specified by a predetermined standards organization. The external application is, for example, software useful for monitoring, for example, ZABBIX.

In doing so, the executer 15a executes installation of an external application downloaded from an external system, for example. After installing an external application, the executer 15a executes startup and predetermined processes and outputs whether the external application can be installed, the startup status of the external application, and the execution result of a predetermined process, as a test result of the external application operation test. Further, the executer 15a stores the test result of the external application operation test into the test result storage 14a in association with the identification information of the control device 50 subjected to the external application operation test. The executer 15a may store the test result into the test result storage 14a additionally in association with information on the external application such as the identification information and the kind of the external application.

### Test Execution Process 7: Application Migration Test Execution Process

The executer 15a executes the application migration test to determine whether the control device 50 can migrate an installed application to a control device 50′ from a different manufacturer.

Here, the application migration test is, for example, a test to determine whether an application already installed on the control device 50 can be migrated to the control device 50′. The control device 50′ may be a device from a product provider P that is a manufacturer different from that of the control device 50, such as a computer with server functions, a monitoring tool, and various devices, and may be a physical device or may be a virtual device.

The predetermined condition specified by the standards organization is, for example, whether an application written in a standard language for control or communication can be ported. Satisfying a predetermined condition specified by another standards organization may be considered as satisfying a predetermined condition specified by a predetermined standards organization.

In doing so, for example, when the control device 50′ is a physical device, the executer 15a accepts, as a predetermined input, input to an input device to start the test, such as a start button installed on the control device 50 or the control device 50′, and executes the application migration test. When the control device 50′ is a virtual device, the executer 15a accepts, for example, input to start the test as a predetermined input and executes the application migration test. The executer 15a installs the application on the control device 50′, transfers data related to the application in the control device 50 to the control device 50′, executes a migration process to migrate the application already installed in the control device 50 to the control device 50′, executes startup and predetermined processes of the application for the control device 50′ that has taken over the application, and outputs whether the application can be installed on the control device 50′, the startup status of the application, and the execution result of the predetermined process, as a test result of the application migration test. Further, the executer 15a stores the test result of the application migration test into the test result storage 14a in association with the identification information of the control device 50 subjected to the application migration test. The executer 15a may store the test result into the test result storage 14a additionally in association with the identification information of the control device 50′ and the like connected to the control device 50.

### Test Execution Process 8: Trouble Test Execution Process

The executer 15a executes the trouble test to determine whether the control device 50 can withstand a predetermined trouble.

Here, the trouble test is, for example, a test to see what results are obtained when a signal similar to a signal that occurs in the event of a trouble in which a predetermined cable connected to the control device 50 is removed is input to the control device 50.

The predetermined condition specified by the standards organization is, for example, removal of power and cables, or switching and fallback that do not affect a control period of 1 second. Satisfying a predetermined condition specified by another standards organization may be considered as satisfying a predetermined condition specified by a predetermined standards organization.

In doing so, the executer 15a inputs to the control device 50 a signal similar to a signal that occurs in the event of a trouble in which a predetermined cable connected to the control device 50 is removed, and outputs the status of the control device 50 after the input of the signal as a test result of the trouble test. Further, the executer 15a stores the test result of the application migration test into the test result storage 14a in association with the identification information of the control device 50 subjected to the application migration test. The executer 15a may store the test result into the test result storage 14a in association with information on the trouble, such as the identification information and the kind of the cable.

### 2-2-5-2. Determiner 15b

The determiner 15b executes a test result acquisition process and a test result determination process (device unit test result determination process, standard application operation test result determination process, software load test result determination process, device interconnection test result determination process, device data linkage test result determination process, external application operation test result determination process, application migration test result determination process, and trouble test result determination process).

### Test Result Acquisition Process

The determiner 15b acquires a test result from the storage unit 14. In doing so, the determiner 15b acquires, from the test result storage 14a, at least one of the test result of the device unit test, the test result of the standard application operation test, the test result of the software load test, the test result of the device interconnection test, the test result of the device data linkage test, the test result of the external application operation test, the test result of the application migration test, and the test result of the trouble test, as a test result.

### Test Result Determination Process 1: Device Unit Test Result Determination Process

The executer 15a determines whether the test result of the device unit test satisfies a predetermined condition.

For example, the determiner 15b determines whether the test result of the device unit test indicates having being working normally. In doing so, the determiner 15b, for example, determines whether the output result for an input signal was a specified value and/or status set in advance, determines whether the function worked normally, and stores the determination result into the determination result storage 14b.

### Test Result Determination Process 2: Standard Application Operation Test Result Determination Process

The executer 15a determines whether the test result of the standard application operation test satisfies a predetermined condition.

For example, the determiner 15b determines whether the test result of the standard application operation test indicates having being able to be installed and operated. In doing so, the determiner 15b, for example, determines whether the standard application was able to be installed and whether the operation status after installation was the status set in advance, determines whether the standard application installed was able to be operated, and stores the determination result into the determination result storage 14b.

### Test Result Determination Process 3: Software Load Test Result Determination Process

The executer 15a determines whether the test result of the software load test satisfies a predetermined condition.

For example, the determiner 15b determines whether the test result of the software load test indicates having being able to withstand a predetermined load. In doing so, the determiner 15b, for example, determines whether at least one of the data communication volume and the data processing volume was a specified value and/or status set in advance, determines whether the software was able to withstand a predetermined load, and stores the determination result into the determination result storage 14b.

### Test Result Determination Process 4: Device Interconnection Test Result Determination Process

The executer 15a determines whether the test result of the device interconnection test satisfies a predetermined condition.

For example, the determiner 15b determines whether the test result of the device interconnection test indicates having being interconnectable. In doing so, the determiner 15b, for example, determines whether the device was connectable and whether the operation status was the status set in advance, determines whether the devices were interconnectable, and stores the determination result into the determination result storage 14b.

### Test Result Determination Process 5: Device Data Linkage Test Result Determination Process

The executer 15a determines whether the test result of the device data linkage test satisfies a predetermined condition.

For example, the determiner 15b determines whether the test result of the device data linkage test indicates that data was able to be transmitted and received. In doing so, the determiner 15b, for example, determines whether predetermined data was able to be transmitted and received and whether the status of transmission and reception was the status set in advance, determines whether data was able to be transmitted and received, and stores the determination result into the determination result storage 14b.

### Test Result Determination Process 6: External Application Operation Test Result Determination Process

The executer 15a determines whether the test result of the external application operation test satisfies a predetermined condition.

For example, the determiner 15b determines whether the test result of the external application operation test indicates having being able to be installed and operated. In doing so, the determiner 15b, for example, determines whether the external application was able to be installed and whether the operation status after installation was the status set in advance, determines whether the external application installed was able to be operated, and stores the determination result into the determination result storage 14b.

### Test Result Determination Process 7: Application Migration Test Result Determination Process

The executer 15a determines whether the test result of the application migration operation test satisfies a predetermined condition.

For example, the determiner 15b determines whether the test result of the application migration test indicates having being able to be migrated. In doing so, the determiner 15b, for example, determines whether the application was able to be installed, whether the migration process was performed normally, and whether the operation status of the migrated application was the status set in advance, determines whether migration was successful, and stores the determination result into the determination result storage 14b.

### Test Result Determination Process 8: Trouble Test Result Determination Process

The executer 15a determines whether the test result of the trouble test satisfies a predetermined condition.

For example, the determiner 15b determines whether the test result of the trouble test indicates having being able to withstand a trouble. In doing so, the determiner 15b, for example, determines whether the status of the control device 50 after a signal input was the status set in advance, determines whether the control device 50 was able to withstand a trouble, and stores the determination result into the determination result storage 14b.

### 2-2-5-3. Certifier 15c

The certifier 15c executes a determination result acquisition process, a control device certification process, a certification result transmission process, a device list creation process, a certificate issuance process, and a control device evaluation process.

### Determination Result Acquisition Process

The certifier 15c acquires a determination result from the storage unit 14. In doing so, the certifier 15c acquires, from the determination result storage 14b, at least one of the determination result of the device unit test, the determination result of the standard application operation test, the determination result of the software load test, the determination result of the device interconnection test, the determination result of the device data linkage test, the determination result of the external application operation test, the determination result of the application migration test, and the determination result of the trouble test, as a determination result.

### Control Device Certification Process

Based on the determination result, the certifier 15c certifies that the control device 50 is compliant with the standards of the standards organization. In doing so, the certifier 15c stores the output certification result into the storage unit 14.

For example, if all of the determination result of the device unit test, the determination result of the standard application operation test, and the determination result of the software load test are “determination result: Pass” indicating that the test result satisfies a predetermined condition, the certifier 15c certifies that the control device 50A is compliant with the OPA standards, generates a certification result indicating that the control device 50A has been certified by OPA, and stores the certification result into the certification result storage 14c. On the other hand, if at least one of the determination result of the device unit test, the determination result of the standard application operation test, and the determination result of the software load test is “determination result: Fail” indicating that the test result does not satisfy a predetermined condition, the certifier 15c does not certify that the control device 50A is compliant with the OPA standards, generates a certification result indicating that the control device 50A has not been certified by OPA, and stores the certification result into the certification result storage 14c.

If all of the determination result of the device unit test, the determination result of the standard application operation test, and the determination result of the software load test are “determination result: Pass” and, in addition, three or more determination results are “determination result: Pass” in tests other than the above tests, the certifier 15c may certify that the control device 50A is compliant with the OPA standards. If all of the determination result of the device unit test, the determination result of the standard application operation test, and the determination result of the software load test are “determination result: Pass” and, in addition, both of the determination result of the device interconnection test and the determination result of the device data linkage test specified by OPA are “determination result: Pass”, the certifier 15c may certify that the control device 50A is compliant with the OPA standards.

### Certification Result Transmission Process

The certifier 15c transmits a certification result. For example, the certifier 15c acquires a certification result from the certification result storage 14c and transmits the certification result to the plant manager terminal 40, the product provider terminal 20, the standards organization terminal 60, and the like.

### Device List Creation Process

The certifier 15c creates a device list of control devices 50 certified as compliant with the standards of the standards organization. In doing so, the certifier 15c may store the created device list into the storage unit 14.

For example, the certifier 15c creates a device list that includes a list of control devices 50 certified as compliant with the OPA standards. In doing so, for one or more control devices 50, the certifier 15c identifies the control devices 50 certified as compliant with the OPA standards by referring to the certification result storage 14c, and creates a device list that collectively lists the identification information and the like of the identified control devices 50. The certifier 15c may create a device list containing items that can uniquely identify the control devices 50, such as identification information, or may create a device list that collectively lists information about the control devices 50, such as the manufacturers, in addition to identification information and the like.

The certifier 15c can also store the created device list into the certification result storage 14c. The certifier 15c can also transmit the created device list to the plant manager terminal 40, the product provider terminal 20, the standards organization terminal 60, and the like. The certifier 15c can also display the created device list on the output unit 12 of the server device 10.

### Certificate Issuance Process

The certifier 15c issues a certificate for the control device 50 certified as compliant with the standards of the standards organization.

For example, the certifier 15c creates a certificate for the control device 50A certified as compliant with the OPA standards. In doing so, the certifier 15c creates a certificate indicating that the control device 50A is compliant with the OPA standards by referring to the certification result storage 14c. The certificate to be created may be based on a predetermined format set in advance and may be an electronic document or a paper document. The content of the certificate to be created may at least indicate that the control device 50 is compliant with the standards of a standards organization such as OPA.

The certifier 15c can also store the created certificate into the certification result storage 14c. When the certificate created is an electronic document, the certifier 15c can also transmit the certificate to the plant manager terminal 40, the product provider terminal 20, the standards organization terminal 60, and the like. The certifier 15c can also display the created certificate on the output unit 12 of the server device 10. When the certificate created is a paper document, the certifier 15c can also transmit the certificate to a printing device or the like and allow the printing device or the like to print the certificate.

### Control Device Evaluation Process

The certifier 15c executes an evaluation of the control device 50 certified as compliant with the standards of the standards organization, based on the test result. In doing so, the certifier 15c notifies the product provider P of the control device 50 of the evaluation result. Further, the certifier 15c notifies the standards organization of the evaluation result.

For example, the certifier 15c executes an evaluation of the control device 50 certified as compliant with the OPA standards, based on each of the test results for the control device 50. Further, the certifier 15c executes an evaluation of the control device 50 certified as compliant with the OPA standards, based on some of the test results for the control device 50.

The certifier 15c executes an evaluation of the control device 50, for example, by the number of stars (e.g., the more stars on a 5-point scale, the higher the evaluation), by the score (e.g., the higher the score out of five, the higher the evaluation), or by alphabets (e.g., the earlier the letter on a 5-point scale from A to E, the higher the evaluation). Here, the certifier 15c executes an evaluation of the control device 50, based on the degree to which each test result satisfies a predetermined condition. Since the predetermined condition is a specified value and/or status set in advance and has a range to some extent, the certifier 15c rates the median value in the range as the highest and decreases the rating as values deviate from the median value. The certifier 15c may execute an evaluation based on a criterion other than the median value, such as the minimum or maximum value in the above range.

The certifier 15c evaluates the control device 50 in the device unit test, based on the degree to which the output result of the control device 50 matches the specified value and/or status set in advance, as a test result of the device unit test. Here, the certifier 15c gives a lower rating when the output result of the control device 50 deviates greatly, and gives a higher rating when it matches.

The certifier 15c executes an evaluation of the control device 50 in the standard application operation test, based on the degree to which the operation status after installation matches the specified value and/or status set in advance, as a test result of the standard application operation test. The certifier 15c gives a lower rating when the operation status after installation deviates greatly, and gives a higher rating when it matches.

The certifier 15c executes an evaluation of the control device 50 in the software load test, based on the degree to which at least one of the data communication volume and the data processing volume matches the specified value and/or status set in advance, as a test result of the software load test. The certifier 15c gives a lower rating when at least one of the data communication volume and the data processing volume deviates greatly, and gives a higher rating when it matches.

The certifier 15c executes an evaluation of the control device 50 in the device interconnection test, based on the degree to which the operation status of each connected device matches the status set in advance, as a test result of the device interconnection test. The certifier 15c gives a lower rating when the operation status of each connected device deviates greatly, and gives a higher rating when it matches.

The certifier 15c executes an evaluation of the control device 50 in the device data linkage test, based on the degree to which the transmission and reception of predetermined data matches the status set in advance, as a test result of the device data linkage test. The certifier 15c gives a lower rating when the transmission and reception of predetermined data deviates greatly, and gives a higher rating when it matches.

The certifier 15c executes an evaluation of the control device 50 in the external application operation test, based on the degree to which the operation status after installation matches the status set in advance, as a test result of the external application operation test. The certifier 15c gives a lower rating when the operation status after installation deviates greatly, and gives a higher rating when it matches.

The certifier 15c executes an evaluation of the control device 50 in the application migration test, based on the degree to which the operation status of the migrated application matches the status set in advance, as a test result of the application migration test. The certifier 15c gives a lower rating when the operation status of the migrated application deviates greatly, and gives a higher rating when it matches.

The certifier 15c executes an evaluation of the control device 50 in the trouble test, based on the degree to which the status of the control device 50 after a signal input matches the status set in advance, as a test result of the trouble test. The certifier 15c gives a lower rating when the status of the control device 50 after a signal input deviates greatly, and gives a higher rating when it matches.

The certifier 15c executes an evaluation on the entire control device 50 using the evaluation result for each test result. The certifier 15c outputs a summary of each individual evaluation result, an average value of the evaluation results, the highest-rated one of the evaluation results, the lowest-rated one of the evaluation results, and the like, as an evaluation for the entire control device 50.

The certifier 15c can also store the output evaluation result into the certification result storage 14c. The certifier 15c can also transmit the output evaluation result to the product provider terminal 20, the standards organization terminal 60, and the like. The certifier 15c can also display the output evaluation result on the output unit 12 of the server device 10.

### 2-3. Configuration Example of Product Provider Terminal 20

Referring to FIG. 3, an example of the product provider terminal 20 illustrated in FIG. 2 will be described. The product provider terminal 20 is a viewing or posting terminal used by the product provider P providing hardware and software that are constituents of the plant control system, and includes an input/output unit 21, a control unit 22, and a communication unit 23.

### 2-3-1. Input/Output Unit 21

The input/output unit 21 governs the input of various information to the product provider terminal 20. For example, the input/output unit 21 is implemented by a mouse, a keyboard, a touch panel, and the like and accepts inputs such as setting information to the product provider terminal 20. Further, the input/output unit 21 governs the display of various information from the product provider terminal 20. For example, the input/output unit 21 is implemented by a display and the like, and displays setting information and the like stored in the product provider terminal 20.

Further, the input/output unit 21 displays the certification results, a device list, certificates, evaluation results, and the like of the control devices 50 transmitted by the server device 10.

### 2-3-2. Control Unit 22

The control unit 22 transmits various information. Further, the control unit 22 receives various information. For example, the control unit 22 receives the certification results, the device list, the certificates, the evaluation results, and the like of the control devices 50 transmitted by the server device 10.

### 2-3-3. Communication Unit 23

The communication unit 23 governs data communication with other devices. For example, the communication unit 23 performs data communication with each communication device via routers and the like. Further, the communication unit 23 can perform data communication with a not-illustrated operator's terminal.

### 2-4. Configuration Example of Plant Manager Terminal 40

Referring to FIG. 3, an example of the plant manager terminal 40 illustrated in FIG. 2 will be described. The plant manager terminal 40 is a posting or viewing terminal used by the plant manager O managing a plant in which the plant control system is introduced, and includes an input/output unit 41, a control unit 42, and a communication unit 43.

### 2-4-1. Input/Output Unit 41

The input/output unit 41 governs the input of various information to the plant manager terminal 40. For example, the input/output unit 41 is implemented by a mouse, a keyboard, a touch panel, and the like and accepts inputs such as setting information to the plant manager terminal 40. Further, the input/output unit 41 governs the display of various information from the plant manager terminal 40. For example, the input/output unit 41 is implemented by a display and the like, and displays setting information and the like stored in the plant manager terminal 40.

Further, the input/output unit 41 displays the certification results, a device list, certificates, and the like of the control devices 50 transmitted by the server device 10.

### 2-4-2. Control Unit 42

The control unit 42 transmits various information. For example, the control unit 42 transmits to the server device 10 a request for certification of OPA, one of the standards organizations, input by the plant manager O via the input/output unit 41.

Further, the control unit 42 receives various information. For example, the control unit 42 receives the certification results, the device list, the certificates, and the like of the control devices 50 transmitted by the server device 10.

### 2-4-3. Communication Unit 43

The communication unit 43 governs data communication with other devices. For example, the communication unit 43 performs data communication with each communication device via routers and the like. Further, the communication unit 43 can perform data communication with a not-illustrated operator's terminal.

### 2-5. Configuration Example and Process Example of Control Device 50

Referring to FIG. 3, an example of the control device 50 illustrated in FIG. 2 will be described. The control device 50 is a plant device that constitutes a plant control system.

The control device 50 is implemented, for example, by gateways suitable for O-PAS communication interface (OCI) which serves a connection function to DCNs and OPA standards non-compliant systems to perform an input/output signal conversion function and a control function in relation to sensors and actuators, and switches, DCNs, or gateways suitable for O-PAS connectivity framework (OCF) which serves a system network communication function.

The control device 50 collects measurement values from sensor devices, communication devices, and the like that constitute the plant control system including the control device 50. Further, the control device 50 calculates a calculation value from the measurement values collected from sensor devices, communication devices, and the like.

Further, the control device 50 transmits to the server device 10 a request for certification of a standards organization such as OPA, input by the plant manager O via the plant manager terminal 40.

### 2-6. Configuration Example of Standards Organization Terminal 60

Referring to FIG. 3, an example of the standards organization terminal 60 illustrated in FIG. 2 will be described. The standards organization terminal 60 is a posting or viewing terminal used by a standards organization and includes an input/output unit 61, a control unit 62, and a communication unit 63.

### 2-6-1. Input/Output Unit 61

The input/output unit 61 governs the input of various information to the standards organization terminal 60. For example, the input/output unit 61 is implemented by a mouse, a keyboard, a touch panel, and the like and accepts inputs such as setting information to the standards organization terminal 60. Further, the input/output unit 61 governs the display of various information from the standards organization terminal 60. For example, the input/output unit 41 is implemented by a display and the like, and displays setting information and the like stored in the standards organization terminal 60.

Further, the input/output unit 61 displays the certification results, a device list, certificates, evaluation results, and the like of the control devices 50 transmitted by the server device 10.

### 2-6-2. Control Unit 62

The control unit 62 transmits various information. Further, the control unit 62 receives various information. For example, the control unit 62 receives the certification results, the device list, the certificates, the evaluation results, and the like of the control devices 50 transmitted by the server device 10.

### 2-6-3. Communication Unit 63

The communication unit 63 governs data communication with other devices. For example, the communication unit 63 performs data communication with each communication device via routers and the like. Further, the communication unit 63 can perform data communication with a not-illustrated operator's terminal.

### 3. Flow of Certification System 100

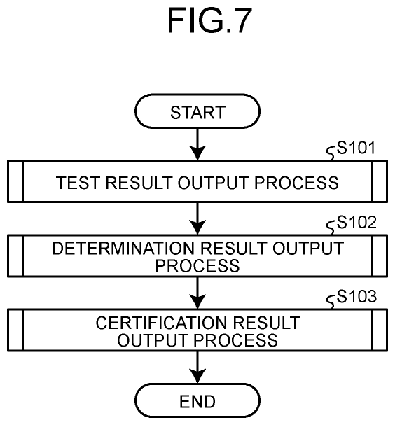

Referring to FIG. 7 to FIG. 10, a process flow of the certification system 100 according to the embodiment will be described. In the following, a process flow of the entire certification system 100 will be described, and then the test result output process, the determination result output process, and the certification result output process will be described.

### 3-1. Process of Entire Certification System 100

Referring to FIG. 7, a process flow of the entire certification system 100 according to the embodiment will be described. FIG. 7 is a flowchart illustrating an example of the flow of the entire certification system 100 according to the embodiment. The processes at steps S101 to S103 below can be performed in a different order. Some of the processes at steps S101 to S103 below may be omitted.

### 3-1-1. Test Result Output Process

First, the server device 10 executes the test result process (step S101). For example, the server device 10 outputs a test result of the control device 50 by executing the processes at steps S201 to S209 described later.

### 3-1-2. Determination Result Output Process

Second, the server device 10 executes the determination result output process (step S102). For example, the server device 10 outputs a determination result of the control device 50 by executing the processes at steps S301 to S310 described later.

### 3-1-3. Certification Result Output Process

Third, the server device 10 executes the certification result output process (step S103). For example, the server device 10 outputs a certification result of the control device 50 by executing the processes at steps S401 to S407 described later.

### 3-2. Test Result Output Process

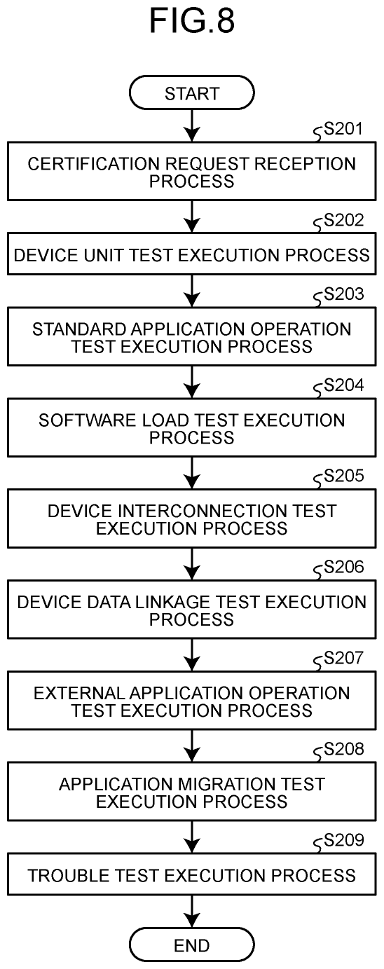

Referring to FIG. 8, a flow of the test result output process of the certification system 100 according to the embodiment will be described. FIG. 8 is a flowchart illustrating an example of the flow of the test result output process of the certification system 100 according to the embodiment. The processes at steps S201 to S209 below can be performed in a different order. Some of the processes at steps S201 to S209 below may be omitted.

### 3-2-1. Certification Request Acceptance Process

First, the server device 10 executes the certification request acceptance process (step S201). For example, the server device 10 accepts a request for certification of OPA from the control device 50.

### 3-2-2. Device Unit Test Execution Process

Second, the server device 10 executes the device unit test execution process (step S202). For example, the server device 10 executes a device unit test to determine whether a function set in the control device 50 satisfies a predetermined condition specified by OPA and works normally.

### 3-2-3. Standard Application Operation Test Execution Process

Third, the server device 10 executes the standard application operation test execution process (step S203). For example, the server device 10 executes a standard application operation test to determine whether the control device 50 satisfies a predetermined condition specified by OPA and can install and operate a standard application specified by OPA.

### 3-2-4. Software Load Test Execution Process

Fourth, the server device 10 executes the software load test execution process (step S204). For example, the server device 10 executes a software load test to determine whether software of the control device 50 satisfies a predetermined condition specified by OPA and can withstand a predetermined load.

### 3-2-5. Device Interconnection Test Execution Process

Fifth, the server device 10 executes the device interconnection test execution process (step S205). For example, the server device 10 executes a device interconnection test to determine whether the control device 50 can interconnect with a control device 50′ from a different manufacturer.

### 3-2-6. Device Data Linkage Test Execution Process

Sixth, the server device 10 executes the device data linkage test execution process (step S206). For example, the server device 10 executes a device data linkage test to determine whether the control device 50 can transmit and receive predetermined data to/from a control device 50′ from a different manufacturer.

### 3-2-7. External Application Operation Test Execution Process

Seventh, the server device 10 executes the external application operation test execution process (step S207). For example, the server device 10 executes an external application operation test to determine whether the control device 50 can install and operate a predetermined external application different from the standard application.

### 3-2-8. Application Migration Test Execution Process

Eighth, the server device 10 executes the application migration test execution process (step S208). For example, the server device 10 executes an application migration test to determine whether the control device 50 can migrate an installed application to a control device 50′ from a different manufacturer.

### 3-2-9. Trouble Test Execution Process

Ninth, the server device 10 executes the trouble test execution process (step S209). For example, the server device 10 executes a trouble test to determine whether the control device 50 can withstand a predetermined trouble, and then terminates the test result output process.

### 3-3. Determination Result Output Process

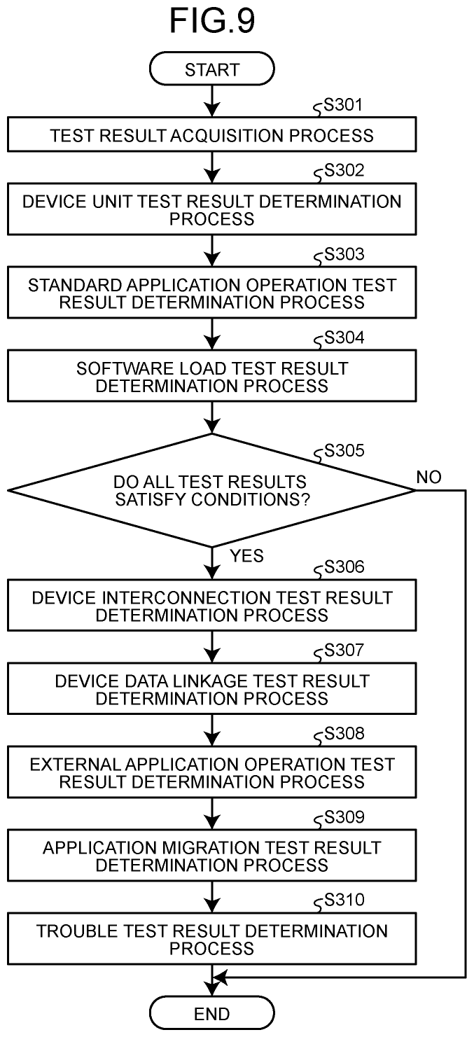

Referring to FIG. 9, a flow of the determination result output process of the certification system 100 according to the embodiment will be described. FIG. 9 is a flowchart illustrating an example of the flow of the determination result output process of the certification system 100 according to the embodiment. The processes at steps S301 to S310 below can be performed in a different order. Some of the processes at steps S301 to S310 below may be omitted.

### 3-3-1. Test Result Acquisition Process

First, the server device 10 executes the test result acquisition process (step S301). For example, the server device 10 acquires, from the test result storage 14a, at least one of the test result of the device unit test, the test result of the standard application operation test, the test result of the software load test, the test result of the device interconnection test, the test result of the device data linkage test, the test result of the external application operation test, the test result of the application migration test, and the test result of the trouble test, as a test result.

### 3-3-2. Device Unit Test Result Determination Process

Second, the server device 10 executes the device unit test result determination process (step S302). For example, the server device 10 determines whether the test result of the device unit test satisfies a predetermined condition.

### 3-3-3. Standard Application Operation Test Result Determination Process

Third, the server device 10 executes the standard application operation test result determination process (step S303). For example, the server device 10 determines whether the test result of the standard application operation test satisfies a predetermined condition.

### 3-3-4. Software Load Test Result Determination Process

Fourth, the server device 10 executes the software load test result determination process (step S304). For example, the server device 10 determines whether the test result of the software load test satisfies a predetermined condition.

Here, the server device 10 moves to the process at step S306 if all of the test results satisfy a predetermined condition at steps S302 to S304 (Yes at step S305). On the other hand, if even one of the test results does not satisfy a predetermined condition at steps S302 to S304 (No at step S305), the server device 10 terminates the determination result output process.

### 3-3-5. Device Interconnection Test Result Determination Process

Fifth, the server device 10 executes the device interconnection test result determination process (step S306). For example, the server device 10 determines whether the test result of the device interconnection test satisfies a predetermined condition.

### 3-3-6. Device Data Linkage Test Result Determination Process

Sixth, the server device 10 executes the device data linkage test result determination process (step S307). For example, the server device 10 determines whether the test result of the device data linkage test satisfies a predetermined condition.

### 3-3-7. External Application Operation Test Result Determination Process

Seventh, the server device 10 executes the external application operation test result determination process (step S308). For example, the server device 10 determines whether the test result of the external application operation test satisfies a predetermined condition.

### 3-3-8. Application Migration Test Result Determination Process

Eighth, the server device 10 executes the application migration test result determination process (step S309). For example, the server device 10 determines whether the test result of the application migration test satisfies a predetermined condition.

### 3-3-9. Trouble Test Result Determination Process

Ninth, the server device 10 executes the trouble test result determination process (step S310). For example, the server device 10 determines whether the test result of the trouble test satisfies a predetermined condition, and then terminates the determination result output process.

### 3-4. Certification Result Output Process

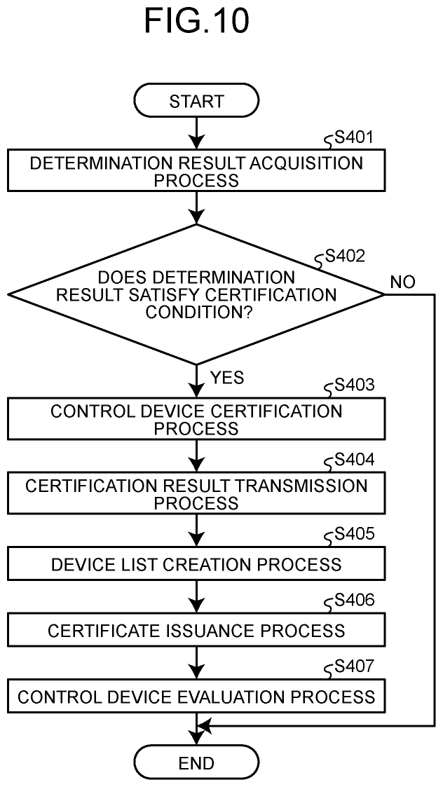

Referring to FIG. 10, a flow of the certification result output process of the certification system 100 according to the embodiment will be described. FIG. 10 is a flowchart illustrating an example of the flow of the certification result output process of the certification system 100 according to the embodiment. The processes at steps S401 to S407 below can be performed in a different order. Some of the processes at steps S401 to S407 below may be omitted.

### 3-4-1. Determination Result Acquisition Process

First, the server device 10 executes the determination result acquisition process (step S401). For example, the server device 10 acquires, from the determination result storage 14b, at least one of the determination result of the device unit test, the determination result of the standard application operation test, the determination result of the software load test, the determination result of the device interconnection test, the determination result of the device data linkage test, the determination result of the external application operation test, the determination result of the application migration test, and the determination result of the trouble test, as a determination result.

Here, the server device 10 moves to the process at step S403 if the determination result satisfies the certification condition specified by a standards organization such as OPA (Yes at step S402). On the other hand, if the determination result does not satisfy the certification condition specified by a standards organization such as OPA (No at step S402), the server device 10 terminates the certification result output process.

### 3-4-2. Control Device Certification Process

Second, the server device 10 executes the control device certification process (step S403). For example, the server device 10 certifies that the control device 50 is compliant with the standards of a standards organization such as OPA, and registers the certification result.

### 3-4-3. Certification Result Transmission Process

Third, the server device 10 executes the certification result transmission process (step S404). For example, the server device 10 transmits the certification result of the control device 50 to at least one of the plant manager terminal 40, the product provider terminal 20, and the standards organization terminal 60.

### 3-4-4. Device List Creation Process

Fourth, the server device 10 executes the device list creation process (step S405). For example, the server device 10 creates a device list of control devices 50 certified as compliant with the standards of a standards organization such as OPA.

### 3-4-5. Certificate Issuance Process

Fifth, the server device 10 executes the certificate issuance process (step S406). For example, the server device 10 issues a certificate for the control device 50 to certify that the control device 50 is compliant with the standards of a standards organization such as OPA.

### 3-4-6. Control Device Evaluation Process

Sixth, the server device 10 executes the control device evaluation process (step S407). For example, the server device 10 executes an evaluation of the control device 50 certified as compliant with the standards of a standards organization such as OPA, based on the test result, and transmits the evaluation result to at least one of the product provider terminal 20 and the standards organization terminal 60.

### 4. Effects of Embodiment

Finally, effects of the embodiment will be described. In the following, effects 1 to 12 corresponding to the processes according to the embodiment will be described.

### 4-1. Effect 1

First, in the process according to the foregoing embodiment, the server device 10 executes a device unit test to determine whether a function set in the control device 50 satisfies a predetermined condition specified by a standards organization and works normally; executes a standard application operation test to determine whether the control device 50 satisfies a predetermined condition specified by the standards organization and can install and operate a standard application specified by the standards organization; executes a software load test to determine whether software of the control device 50 satisfies a predetermined condition specified by the standards organization and can withstand a predetermined load; determines whether each of the test results of the device unit test, the standard application operation test, and the software load test satisfies a predetermined condition; and certifies that the control device 50 is compliant with standards of the standards organization, based on the determination result. The process according to the embodiment therefore can efficiently certify that the control device 50 that constitutes the plant control system is compliant with the standards of the standards organization.

### 4-2. Effect 2

Second, in the process according to the foregoing embodiment, the standards organization is OPA, MTP, or NOA. The process according to the embodiment therefore can efficiently certify that the control device 50 that constitutes the plant control system is compliant with the standards of a standards organization such as OPA.

### 4-3. Effect 3

Third, in the process according to the foregoing embodiment, the server device 10 executes a device interconnection test to determine whether the control device 50 can interconnect with a control device 50′ from a different manufacturer, determines whether the test result of the device interconnection test satisfies a predetermined condition, and certifies that the control device 50 is compliant with the standards of the standards organization, based on the determination result of the device interconnection test. The process according to the embodiment therefore can efficiently certify that the control device 50 that constitutes the plant control system is compliant with the standards of the standards organization, by further executing the device interconnection test.

### 4-4. Effect 4

Fourth, in the process according to the foregoing embodiment, the server device 10 executes a device data linkage test to determine whether the control device 50 can transmit and receive predetermined data to/from a control device 50′ from a different manufacturer, determines whether the test result of the device data linkage test satisfies a predetermined condition, and certifies that the control device 50 is compliant with the standards of the standards organization, based on the determination result of the device data linkage test. The process according to the embodiment therefore can efficiently certify that the control device 50 that constitutes the plant control system is compliant with the standards of the standards organization, by further executing the device data linkage test.

### 4-5. Effect 5

Fifth, in the process according to the foregoing embodiment, the server device 10 executes an external application operation test to determine whether the control device 50 can install and operate a predetermined external application different from the standard application, determines whether the test result of the external application operation test satisfies a predetermined condition, and certifies that the control device 50 is compliant with the standards of the standards organization, based on the determination result of the external application operation test. The process according to the embodiment therefore can efficiently certify that the control device 50 that constitutes the plant control system is compliant with the standards of the standards organization, by further executing the external application operation test.

### 4-6. Effect 6

Sixth, in the process according to the foregoing embodiment, the server device 10 executes an application migration test to determine whether the control device 50 can migrate an installed application to a control device 50′ from a different manufacturer, determines whether the test result of the application migration test satisfies a predetermined condition, and certifies that the control device 50 is compliant with the standards of the standards organization, based on the determination result of the application migration test. The process according to the embodiment therefore can efficiently certify that the control device 50 that constitutes the plant control system is compliant with the standards of the standards organization, by further executing the application migration test.

### 4-7. Effect 7

Seventh, in the process according to the foregoing embodiment, the server device 10 executes a trouble test to determine whether the control device 50 can withstand a predetermined trouble, determines whether the test result of the trouble test satisfies a predetermined condition, and certifies that the control device 50 is compliant with the standards of the standards organization, based on the determination result of the trouble test. The process according to the embodiment therefore can efficiently certify that the control device 50 that constitutes the plant control system is compliant with the standards of the standards organization, by further executing the trouble test.

### 4-8. Effect 8

Eighth, in the process according to the foregoing embodiment, the server device 10 creates a device list of control devices 50 certified as compliant with the standards of the standards organization. The process according to the embodiment therefore can efficiently certify that the control device 50 that constitutes the plant control system is compliant with the standards of the standards organization, and can easily identify the certified control device 50.

### 4-9. Effect 9

Ninth, in the process according to the foregoing embodiment, the server device 10 issues a certificate for the control device 50 certified as compliant with the standards of the standards organization. The process according to the embodiment therefore can efficiently certify that the control device 50 that constitutes the plant control system is compliant with the standards of the standards organization, and can easily prove the certified control device 50.

### 4-10. Effect 10

Tenth, in the process according to the foregoing embodiment, the server device 10 executes an evaluation of the control device 50 certified as compliant with the standards of the standards organization, based on the test result. The process according to the embodiment therefore can efficiently certify that the control device 50 that constitutes the plant control system is compliant with the standards of the standards organization, and can easily evaluate the certified control device 50.

### 4-11. Effect 11

Eleventh, in the process according to the foregoing embodiment, the server device 10 notifies the product provider of the control device 50 of the evaluation result. The process according to the embodiment therefore can efficiently certify that the control device 50 that constitutes the plant control system is compliant with the standards of the standards organization, and can easily provide the product provider P with the evaluation of the certified control device 50.

### 4-12. Effect 12

Twelfth, in the process according to the foregoing embodiment, the server device 10 notifies the standards organization of the evaluation result. The process according to the embodiment therefore can efficiently certify that the control device 50 that constitutes the plant control system is compliant with the standards of the standards organization, and can provide the standards organization with the evaluation of the certified control device 50.

### System

The process procedures, control procedures, specific names, and information including various data and parameters set forth in the above document and drawings can be changed as desired, unless otherwise specified.

In addition, the constituents of devices illustrated in the drawings are a functional concept and are not necessarily physically configured as illustrated in the drawings. In other words, the specific forms of distribution and integration of devices are not limited to those illustrated in the drawings. In other words, all or some of the devices can be functionally or physically distributed or integrated in any units according to various loads and usage conditions.

Furthermore, the processing function performed by each device can be implemented entirely or partially by a CPU and a computer program that is analyzed and executed by the CPU, or by hardware using wired logic.

### Hardware

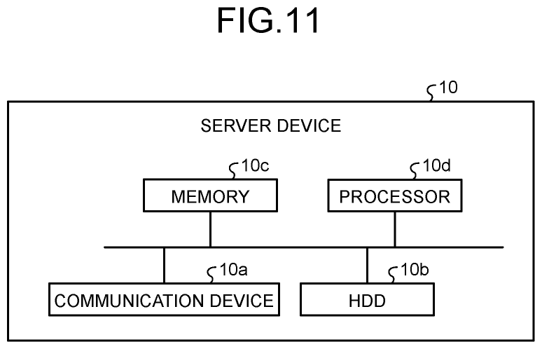

A hardware configuration example of the server device 10 will now be described. FIG. 11 is a diagram illustrating a hardware configuration example. As illustrated in FIG. 11, the server device 10 includes a communication device 10a, a hard disk drive (HDD) 10b, a memory 10c, and a processor 10d. The parts illustrated in FIG. 11 are connected to each other, for example, by a bus.

The communication device 10a is, for example, a network interface card to communicate with other servers. The HDD 10b stores therein computer programs and DBs to operate the functions illustrated in FIG. 3.

The processor 10d reads a computer program for executing the same process as each processing unit illustrated in FIG. 3 from the HDD 10b or the like and loads the computer program into the memory 10c to operate a process that executes each function described in FIG. 3 and the like. For example, this process executes the same function as each processing unit of the server device 10. Specifically, the processor 10d reads computer programs having the same functions as the executer 15a, the determiner 15b, and the certifier 15c from the HDD 10b, for example. The processor 10d then executes the same processing as the executer 15a, the determiner 15b, and the certifier 15c.

In this way, the server device 10 operates as a device that executes various processing methods by reading and executing a computer program. The server device 10 may read the above computer program from a recording medium by a medium reader and execute the read computer program to achieve the same functions as in the foregoing embodiment. The computer program referred to in other embodiments is not limited to being executed by the server device 10. For example, the present invention can be applied equally when another computer or server executes the computer program or when they cooperate to execute the computer program.

The computer program can be distributed via a network such as the Internet. The computer program can also be recorded on a computer-readable recording medium such as a hard disk, a flexible disk (FD), a CD-ROM, a magneto-optical disk (MO), and a digital versatile disc (DVD) and read from the recording medium and executed by a computer.

### Others

Some examples of combinations of the disclosed technical features will be described below.
(1) A certification system including a control device that constitutes a plant control system, and a certification device that executes certification of the control device, the certification device including: an executer configured to execute a device unit test to determine whether a function set in the control device satisfies a predetermined condition specified by a standards organization and works normally, execute a standard application operation test to determine whether the control device satisfies a predetermined condition specified by the standards organization and is capable of installing and operating a standard application specified by the standards organization, and execute a software load test to determine whether software of the control device satisfies a predetermined condition specified by the standards organization and is capable of withstanding a predetermined load; a determiner configured to determine whether each of test results of the device unit test, the standard application operation test, and the software load test satisfies a predetermined condition; and a certifier configured to certify that the control device is compliant with standards of the standards organization, based on the determination result.
(2) The certification system according to (1), wherein the standards organization is OPA, MTP, or NOA.
(3) The certification system according to (1) or (2), wherein the executer further executes a device interconnection test to determine whether the control device is capable of interconnecting with a control device from a different manufacturer, the determiner further determines whether a test result of the device interconnection test satisfies a predetermined condition, and the certifier certifies that the control device is compliant with standards of the standards organization, based on the determination result further including a determination result of the device interconnection test.
(4) The certification system according to any one of (1) to (3), wherein the executer further executes a device data linkage test to determine whether the control device is capable of transmitting and receiving predetermined data to/from a control device from a different manufacturer, the determiner further determines whether a test result of the device data linkage test satisfies a predetermined condition, and the certifier certifies that the control device is compliant with standards of the standards organization, based on the determination result further including a determination result of the device data linkage test.
(5) The certification system according to any one of (1) to (4), wherein the executer further executes an external application operation test to determine whether the control device is capable of installing and operating a predetermined external application different from the standard application, the determiner further determines whether a test result of the external application operation test satisfies a predetermined condition, and the certifier certifies that the control device is compliant with standards of the standards organization, based on the determination result further including a determination result of the external application operation test.
(6) The certification system according to any one of (1) to (5), wherein the executer further executes an application migration test to determine whether the control device is capable of migrating an installed application to a control device from a different manufacturer, the determiner further determines whether a test result of the application migration test satisfies a predetermined condition, and the certifier certifies that the control device is compliant with standards of the standards organization, based on the determination result further including a determination result of the application migration test.
(7) The certification system according to any one of (1) to (6), wherein the executer further executes a trouble test to determine whether the control device is capable of withstanding a predetermined trouble, the determiner further determines whether a test result of the trouble test satisfies a predetermined condition, and the certifier certifies that the control device is compliant with standards of the standards organization, based on the determination result further including a determination result of the trouble test.
(8) The certification system according to any one of (1) to (7), wherein the certifier creates a device list of the control device certified as compliant with standards of the standards organization.
(9) The certification system according to any one of (1) to (8), wherein the certifier issues a certificate for the control device certified as compliant with standards of the standards organization.
(10) The certification system according to any one of (1) to (9), wherein the certifier executes an evaluation of the control device certified as compliant with standards of the standards organization, based on the test result.
(11) The certification system according to (10), wherein the certifier notifies a product provider of the control device of the evaluation result.
(12) The certification system according to (10) or (11), wherein the certifier notifies the standards organization of the evaluation result.
(13) A certification method executed in a certification system including a control device that constitutes a plant control system, and a certification device that executes certification of the control device, wherein the certification device performs processing including: executing a device unit test to determine whether a function set in the control device satisfies a predetermined condition specified by a standards organization and works normally; executing a standard application operation test to determine whether the control device satisfies a predetermined condition specified by the standards organization and is capable of installing and operating a standard application specified by the standards organization; executing a software load test to determine whether software of the control device satisfies a predetermined condition specified by the standards organization and is capable of withstanding a predetermined load; determining whether each of test results of the device unit test, the standard application operation test, and the software load test satisfies a predetermined condition; and certifying that the control device is compliant with standards of the standards organization, based on a determination result.
(14) A certification program for causing a certification device that executes certification of a control device that constitutes a plant control system to execute processing including: executing a device unit test to determine whether a function set in the control device satisfies a predetermined condition specified by a standards organization and works normally; executing a standard application operation test to determine whether the control device satisfies a predetermined condition specified by the standards organization and is capable of installing and operating a standard application specified by the standards organization; executing a software load test to determine whether software of the control device satisfies a predetermined condition specified by the standards organization and is capable of withstanding a predetermined load; determining whether each of test results of the device unit test, the standard application operation test, and the software load test satisfies a predetermined condition; and certifying that the control device is compliant with standards of the standards organization, based on a determination result.

1. A certification system comprising a control device that constitutes a plant control system, and a certification device that executes certification of the control device,
the certification device comprising:
an executer configured to
execute a device unit test to determine whether a function set in the control device satisfies a predetermined condition specified by a standards organization and works normally,
execute a standard application operation test to determine whether the control device satisfies a predetermined condition specified by the standards organization and is capable of installing and operating a standard application specified by the standards organization, and
execute a software load test to determine whether software of the control device satisfies a predetermined condition specified by the standards organization and is capable of withstanding a predetermined load;
a determiner configured to determine whether each of test results of the device unit test, the standard application operation test, and the software load test satisfies a predetermined condition; and
a certifier configured to certify that the control device is compliant with standards of the standards organization, based on the determination result.

2. The certification system according to claim 1, wherein the standards organization is Open Process Automation (OPA), Module Type Package (MTP), or NAMUR Open Architecture (NOA).

3. The certification system according to claim 1, wherein
the executer further executes a device interconnection test to determine whether the control device is capable of interconnecting with a control device from a different manufacturer,
the determiner further determines whether a test result of the device interconnection test satisfies a predetermined condition, and
the certifier certifies that the control device is compliant with standards of the standards organization, based on the determination result further including a determination result of the device interconnection test.

4. The certification system according to claim 1, wherein
the executer further executes a device data linkage test to determine whether the control device is capable of transmitting and receiving predetermined data to/from a control device from a different manufacturer,
the determiner further determines whether a test result of the device data linkage test satisfies a predetermined condition, and
the certifier certifies that the control device is compliant with standards of the standards organization, based on the determination result further including a determination result of the device data linkage test.

5. The certification system according to claim 1, wherein
the executer further executes an external application operation test to determine whether the control device is capable of installing and operating a predetermined external application different from the standard application,
the determiner further determines whether a test result of the external application operation test satisfies a predetermined condition, and
the certifier certifies that the control device is compliant with standards of the standards organization, based on the determination result further including a determination result of the external application operation test.

6. The certification system according to claim 1, wherein
the executer further executes an application migration test to determine whether the control device is capable of migrating an installed application to a control device from a different manufacturer,
the determiner further determines whether a test result of the application migration test satisfies a predetermined condition, and
the certifier certifies that the control device is compliant with standards of the standards organization, based on the determination result further including a determination result of the application migration test.

7. The certification system according to claim 1, wherein
the executer further executes a trouble test to determine whether the control device is capable of withstanding a predetermined trouble,
the determiner further determines whether a test result of the trouble test satisfies a predetermined condition, and
the certifier certifies that the control device is compliant with standards of the standards organization, based on the determination result further including a determination result of the trouble test.

8. The certification system according to claim 1, wherein the certifier creates a device list of the control device certified as compliant with standards of the standards organization.

9. The certification system according to claim 1, wherein the certifier issues a certificate for the control device certified as compliant with standards of the standards organization.

10. The certification system according to claim 1, wherein the certifier executes an evaluation of the control device certified as compliant with standards of the standards organization, based on the test result.

11. The certification system according to claim 10, wherein the certifier notifies a product provider of the control device of an evaluation result.

12. The certification system according to claim 10, wherein the certifier notifies the standards organization of an evaluation result.

13. A certification method executed in a certification system comprising a control device that constitutes a plant control system, and a certification device that executes certification of the control device, wherein
the certification device performs processing comprising:
executing a device unit test to determine whether a function set in the control device satisfies a predetermined condition specified by a standards organization and works normally;
executing a standard application operation test to determine whether the control device satisfies a predetermined condition specified by the standards organization and is capable of installing and operating a standard application specified by the standards organization;
executing a software load test to determine whether software of the control device satisfies a predetermined condition specified by the standards organization and is capable of withstanding a predetermined load;
determining whether each of test results of the device unit test, the standard application operation test, and the software load test satisfies a predetermined condition; and
certifying that the control device is compliant with standards of the standards organization, based on the determination result.

14. A computer-readable recording medium storing therein a certification program for causing a certification device that executes certification of a control device that constitutes a plant control system to execute processing comprising:
executing a device unit test to determine whether a function set in the control device satisfies a predetermined condition specified by a standards organization and works normally;
executing a standard application operation test to determine whether the control device satisfies a predetermined condition specified by the standards organization and is capable of installing and operating a standard application specified by the standards organization;
executing a software load test to determine whether software of the control device satisfies a predetermined condition specified by the standards organization and is capable of withstanding a predetermined load;
determining whether each of test results of the device unit test, the standard application operation test, and the software load test satisfies a predetermined condition; and
certifying that the control device is compliant with standards of the standards organization, based on the determination result.
